(19) United States
(12) Patent Application Publication
(10) Pub. No.: US 2025/0202919 A1
(43) Pub. Date: Jun. 19, 2025

(54) SYSTEM AND METHOD FOR DETECTING BOT THROUGH MISSING API REQUESTS AND SEQUENCE INTEGRITY ANALYSIS

(71) Applicant: Traceable Inc, San Francisco, CA (US)

(72) Inventors: Sanjay Nagaraj, Dublin, CA (US); Ayan Halder, Mountain House, CA (US); Dheeraj Vanagundhi Chandrashekar, San Jose, CA (US); Sunil Babu Venkata Gattupalle, San Ramon, CA (US); Anand Prakash Tiwary, Everett, WA (US)

(73) Assignee: Traceable Inc, San Francisco, CA (US)

(21) Appl. No.: 19/073,060

(22) Filed: Mar. 7, 2025

Related U.S. Application Data
(63) Continuation-in-part of application No. 18/419,593, filed on Jan. 23, 2024.
(60) Provisional application No. 63/510,151, filed on Jun. 26, 2023.

(51) Int. Cl. H04L 9/40

(52) U.S. Cl. CPC H04L 63/1425; H04L 63/1433; H04L 2463/144

(57) ABSTRACT

A method for detecting and preventing bot activity in a protected environment by leveraging API behavior analysis is disclosed. The method includes identifying target APIs vulnerable to bot attacks through the analysis of parameters such as user credentials and session tokens. It determines the importance of target APIs based on call volume and context, generating correlation keys from headers, cookies, or payloads to track API flows. The method identifies mandatory and probable pre-APIs using historical patterns, assigns risk scores based on criticality, and validates API request sequences in real-time by analyzing integrity and sequence likelihood. Caching mechanisms store data related to APIs, correlation keys, and invocation paths for real-time lookups. Incoming requests are assessed for missing pre-APIs or sequence deviations, with substitute APIs validated against thresholds. Requests flagged as bot traffic are blocked, ensuring secure API workflows and mitigating automated threats effectively.

### CROSS-REFERENCE TO RELATED APPLICATIONS

This application is a Continuation-In-Part (CIP) of U.S. patent application Ser. No. 18/419,593, titled “Generalized Behavior Analytics Framework for Detecting and Preventing Different Types of API Security Vulnerabilities”, filed on 23 Jan. 2024, which further derives priority from U.S. Provisional Patent Application 63/510,151, filed on 26 Jun. 2023, the entirety of which are incorporated herein by reference.

### BACKGROUND

### Technical Field

The present disclosure relates to the field of cybersecurity and bot detection, and particularly relates to a system and method for detecting and preventing bot activity by identifying missing API requests and analyzing API sequence integrity.

### Description of the Related Art

Modern digital applications rely heavily on Application Programming Interfaces (APIs) to facilitate communication between client devices and backend services. APIs are integral to functions such as authentication, authorization, data retrieval, financial transactions, and user interactions, making them a prime target for cyber threats. One of the most persistent threats to API security is automated bot activity, where malicious actors exploit APIs to conduct large-scale attacks, including credential stuffing, fake registrations, carding, web scraping, and data exfiltration. These attacks often rely on automated scripts or bots that mimic legitimate user interactions while executing fraudulent operations at scale.

Traditional bot mitigation techniques such as rate limiting, CAPTCHA verification, and IP-based blocking have proven insufficient as attackers increasingly employ rotating IPs, headless browsers, and human-like behavioral patterns to evade detection. While some existing solutions analyze API request anomalies, they fail to address a critical aspect of bot behavior—the systematic absence of expected API calls. Attackers often bypass the intended API flow by directly invoking high-value APIs, such as authentication or payment processing endpoints, while skipping intermediary API requests that would normally be triggered during a legitimate user session. This circumvention leaves behind incomplete or out-of-sequence API requests, disrupting the expected API sequence integrity and generating an identifiable anomaly in the request flow. Additionally, bot-generated API requests often lack expected metadata, such as cookies, session tokens, or other contextual parameters, due to the absence of legitimate front-end interaction. These discrepancies create a distinct signature that distinguishes automated bot activity from human-generated traffic. However, current security measures do not effectively leverage these behavioral gaps to detect and block malicious bot traffic in real time.

Therefore, there is a need for a system and method capable of detecting bot activity by analyzing API invocation chains, identifying missing API requests, validating API sequence integrity, and improving the API security of a protected environment.

### BRIEF SUMMARY

One or more embodiments are directed to a system and method (together termed as “mechanism”) for detecting and preventing bot activity in a protected environment. The mechanism ensures the security of APIs by monitoring the flow of requests, validating their sequence integrity, and identifying deviations that signal malicious activity. The mechanism operates by analyzing incoming API requests to determine whether they follow expected patterns, adhere to predefined sequences, and include mandatory steps in the request flow. Such checks are essential for distinguishing legitimate traffic from bot-generated requests, which often bypass critical API calls to directly access sensitive endpoints. Further, the mechanism evaluates API requests in real-time, comparing them against historical patterns and predefined rules to detect anomalies such as missing pre-API calls, unexpected sequences, and irregular invocation paths. For example, in legitimate user interactions, a request to an API endpoint responsible for payment processing would typically be preceded by authentication and validation steps. The mechanism identifies and flags instances where these essential steps are bypassed, as this is a common trait of bot activity. Further, the mechanism assesses the logical relationships between API requests to validate their consistency and coherence, ensuring that requests are properly linked and executed in the intended order.

To achieve accurate detection, the mechanism utilizes a dynamic approach that continuously updates its understanding of normal API behavior by analyzing data trends and adapting to changing usage patterns. The mechanism collects and stores data related to API flows, such as historical invocation chains, expected dependencies, and sequence patterns, enabling it to detect deviations in real-time. Further, the mechanism also evaluates risk based on multiple parameters, including the likelihood of sequence violations, the presence of missing API requests, and abnormal patterns in user interactions. Based on these risk assessments, appropriate actions are taken to mitigate threats, such as blocking suspicious traffic, imposing rate limits, or triggering additional authentication steps.

In an embodiment, the mechanism addresses a critical gap in existing API security systems by focusing on the detection of sophisticated bot activity. Unlike traditional methods such as rate limiting, CAPTCHAs, or static rule-based systems, the mechanism detects and prevents attacks that exploit vulnerabilities in API flows, such as low-frequency bot attacks or those mimicking human-like behavior. Further, the mechanism provides a proactive approach to identifying threats by validating the completeness and integrity of API request flows, which is particularly effective in countering advanced bots that attempt to evade detection by simulating legitimate user interactions. Furthermore, the mechanism enables the protection of sensitive data and prevents API fraud by correlating data across multiple layers, including user behavior, request metadata, and invocation paths. The disclosed mechanism integrates seamlessly with existing API gateways and backend systems, making it a scalable and adaptable solution for securing APIs in various industries, including e-commerce, banking, and healthcare. By ensuring that only legitimate traffic reaches protected endpoints, the mechanism enhances the security and reliability of API ecosystems while minimizing disruptions to genuine users.

An embodiment of the present disclosure discloses a system for detecting and preventing bot activity in a protected environment. The system operates by evaluating API sequences, tracking correlation keys, and ensuring that expected pre-API requests are invoked before accessing sensitive services. The system processes API request metadata, analyzes deviations in API flow patterns, and enforces security policies to prevent automated attacks.

In an embodiment, the system includes a target API identifier engine for identifying APIs that are susceptible to bot-based attacks by analyzing API request parameters including, without any limitation, user sensitive information, payment details, or session tokens to classify such APIs as high-risk based on their sensitivity. Additionally, the system may assess the call volume and usage context of APIs to determine their likelihood of being targeted by bots. It may be apparent to a person skilled in the art that the APIs exhibiting unusually high request frequencies, atypical access patterns, or requests originating from multiple sources within a short time frame are flagged for further analysis. Further, to enhance accuracy, the target API identifier engine may employ Machine Learning (ML) models to classify APIs based on various parameters, including historical call volume and presence of security-sensitive fields. The ML models dynamically adjust API risk rankings based on ongoing threat intelligence and anomaly detection results, ensuring that bot targeting behaviors are continuously identified and mitigated.

In an embodiment, the system includes a correlation key tracking engine that establishes logical connections between API requests. The correlation key tracking engine generates correlation keys from API request headers, cookies, and/or payload attributes, enabling the system to track API flows within a session. The correlation keys serve as unique identifiers, facilitating the system to reconstruct user journey pathways and identify anomalies in API request sequences. To refine the correlation capabilities, the correlation key tracking engine creates one or more clusters of the correlated keys and assigns unique identifiers to correlation keys for tracking API flows to the target API and selects statistically significant attributes from historical logs to generate optimal correlation keys. By focusing on user identifiers, session attributes, or device-specific metadata, the system ensures that correlation keys are robust and resistant to bot obfuscation techniques. Further, the correlation key mappings are maintained in a dedicated storage module, allowing for real-time lookups and integrity validation.

In an embodiment, the system includes a pre-API detection engine to ensure that critical API requests are preceded by expected pre-API calls. The pre-API detection engine evaluates historical API sequences and user workflows to determine which APIs should be invoked before accessing high-risk endpoints. If an API request arrives without its expected pre-API calls, the pre-API detection engine assigns a risk score based on the severity of the omission and the likelihood that the request originates from an automated script. Further, to enhance its ability to track multiple API pathways, the pre-API detection engine constructs an API correlation graph that maps out common user journeys. Such correlation graph accounts for alternate API paths, parallel processes, and session-dependent workflows, ensuring that legitimate variations in API sequences are not mistakenly flagged as bot activity. Additionally, the pre-API detection engine may assign replacement APIs to expected pre-APIs, determining whether alternative API calls serve a similar function within a given workflow.

In an embodiment, the system includes an API sequence integrity engine that verifies whether API requests adhere to historically observed invocation patterns. The API sequence integrity engine assigns likelihood scores to API sequences by comparing the sequence of API requests to the sequence of correlated pre-APIs. The requests deviating from established patterns are flagged for further analysis, with high-risk deviations triggering immediate security enforcement measures. Further, to detect low-frequency and adaptive bot behaviors, the API sequence integrity validation engine continuously updates its sequence likelihood models based on new traffic patterns. Additionally, the API sequence integrity validation engine monitors sudden spikes in usage of uncommon API paths, as the sudden spikes may indicate the presence of automation frameworks attempting to bypass conventional security measures.

In an embodiment, the system includes a storage engine to maintain structured API tracking data. The storage engine consists of multiple storage components, each designed for a specific aspect of API behavior analysis. The target API store retains metadata associated with sensitive APIs, while the correlation key store maintains mappings of correlation keys and their associated API flows. Similarly, the pre-API store tracks expected API invocation sequences, and the path integrity store records valid API invocation pathways. By caching API flow information, the storage engine enables real-time request validation, efficient correlation key lookups, and rapid anomaly detection. Further, the storage engine dynamically updates its contents based on recent API traffic patterns and risk assessment results, ensuring that the storage engine remains adaptive to evolving bot tactics.

In an embodiment, the system includes a decision engine to flag suspicious bot activity based on the results of the comparison by analyzing incoming API requests and determine whether they exhibit bot-like characteristics. The decision engine evaluates API flows for missing pre-APIs, correlation key mismatches, and sequence integrity violations, assigning dynamic risk scores to each request. If an API request fails multiple validation checks, the decision engine may block subsequent API requests to the target API if a number of subsequent API requests not following the determined sequence of API requests exceed a predefined threshold. Further, the decision engine flags suspicious bot activity of the comparison indicates that one or more of a critical API and a closely resembling API to the critical API is missing from the sequence of correlated pre-APIs, wherein such indication from comparison is determined if difference is more than a pre-defined threshold. Additionally, the decision engine may dynamically adjust its risk thresholds based on administrator-defined configurations, historical security incidents, or evolving attack trends. To mitigate bot activity in real-time, the decision engine implements adaptive response measures that escalate based on risk levels. Low-risk anomalies may trigger additional authentication steps, whereas high-risk bot activity results in immediate blocking or rate limiting of API requests. Such enforcement actions can be dynamically updated based on security policies or automated learning models, ensuring that mitigation strategies remain effective against new and emerging bot techniques.

An embodiment of the present disclosure discloses a method for detecting and preventing bot activity in a protected environment by analyzing API request patterns, validating sequence integrity, and identifying deviations indicative of bot-generated traffic. The method includes the steps of identifying target APIs that are susceptible to bot attacks by analyzing API body parameters, including user sensitive information, payment information, and/or session tokens. The method further includes the steps of determining the importance of the target APIs based on factors such as average call volume and usage context to assess the likelihood of bot exploitation. Further, the method includes the steps of generating correlation keys from API headers, cookies, and/or payloads to create logical chains of API requests, enabling the tracking of API invocation sequences. Next, the method includes the steps of assigning unique identifiers to correlation keys to ensure accurate monitoring of API flows directed toward target APIs. The method also includes the steps of selecting statistically significant user data from historical logs to derive optimal correlation keys that enhance tracking precision and prevent bot obfuscation.

In an embodiment, the method includes the steps of identifying pre-APIs associated with the target API based on the generated correlation keys. Next, the method further includes the steps of assigning a risk score to the pre-APIs based on their frequency and criticality within the API workflow. Further, the method also includes the steps of constructing an API correlation graph to handle multiple pathways in the user journey toward the target API, ensuring that legitimate variations in API sequences are accounted for while detecting bot-generated traffic. Additionally, the method includes the steps of assigning replacement APIs for missing pre-APIs and determining their likelihood of substitution based on usage patterns.

In an embodiment, the method includes the steps of determining a sequence of API requests and assigning likelihood scores to API paths based on historical data. The method further includes the steps of comparing the sequence of API requests to the sequence of correlated pre-APIs to detect unauthorized deviations. The method also includes the steps of calculating sequence likelihood scores by comparing current API paths with historical data validated as benign. Additionally, the method includes the steps of monitoring sudden spikes in the usage of uncommon paths to detect malicious traffic patterns. In an embodiment, the method includes the steps of caching data related to target APIs, correlation keys, pre-APIs, replacement APIs, and sequence paths for real-time lookups. The method further includes the steps of maintaining a structured data storage mechanism, including a target API store for caching metadata, a correlation key store for tracking API mappings, a pre-API store for storing pre-APIs and their associated risk scores, and a path integrity store for recording valid API sequences and their probability scores. The method includes the steps of flagging suspicious bot activity based on the results of the comparison. Further, the method includes the steps of flagging suspicious bot activity if the comparison indicates that one or more of: a critical API and a closely resembling API to the critical API is missing from the sequence of correlated pre-APIs, wherein such indication from comparison is determined if difference is more than a pre-defined threshold.

In an embodiment, the method includes the steps of analyzing incoming API requests for missing pre-APIs or deviations in sequence integrity. The method further includes the steps of validating substitute APIs against replacement thresholds to ensure that missing pre-API calls do not introduce vulnerabilities in API workflows. The method also includes the steps of blocking API requests flagged as bot traffic based on predefined risk thresholds. Additionally, the method includes the steps of dynamically updating risk thresholds based on administrator-defined configurations or historical incident data. Further, the method includes the steps of blocking subsequent API requests to the target API if a number of subsequent API requests not following the determined sequence of API requests exceed a predefined threshold. Accordingly, the method includes enabling real-time detection and mitigation of bot activity within a protected API environment, ensuring the prevention of automated attacks while maintaining seamless operation for legitimate users.

The features and advantages of the subject matter here will become more apparent in light of the following detailed description of selected embodiments, as illustrated in the accompanying FIGUREs. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary environment of a system for detecting and preventing bot activity in a protected environment, in accordance with an embodiment of the present disclosure.

FIG. 2 illustrates a detailed block diagram showing functional modules of the system for detecting and preventing bot activity in a protected environment, in accordance with an embodiment of the present disclosure.

FIG. 3 shows exemplary data that is stored in an API data lake, in accordance with an embodiment of the present disclosure.

FIG. 4 shows exemplary uses of the API data lake that provides 360-degree contextual data of each API, in accordance with an embodiment of the present disclosure.

FIG. 5A shows a correlation key tracking mechanism, in accordance with an embodiment of the present disclosure.

FIG. 5B shows a correlation key chain construction, in accordance with an embodiment of the present disclosure.

FIG. 6 shows exemplary pre-API detection workflow, in accordance with an embodiment of the present disclosure.

FIG. 7 shows an API sequence integrity analysis model, in accordance with an embodiment of the present disclosure.

FIG. 8 shows a bot detection decision flow, in accordance with an embodiment of the present disclosure.

FIG. 9 shows a storage engine and API flow validation model, in accordance with an embodiment of the present disclosure.

FIG. 10 shows a block diagram illustrating an exemplary data collection and bot detection workflow, in accordance with an embodiment of the present disclosure.

FIG. 11 is a flow chart of a method for detecting and preventing bot activity in a protected environment, in accordance with an embodiment of the present disclosure.

FIG. 12 illustrates an exemplary computer unit in which or with which embodiments of the present disclosure may be utilized.

Other features of embodiments of the present disclosure will be apparent from accompanying drawings and detailed description that follows.

### DETAILED DESCRIPTION

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product.

### Terminology

Brief definitions of terms used throughout this application are given below.

The terms “connected” or “coupled”, and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

One or more embodiments are directed to a system and method (together termed as “mechanism”) for detecting and preventing bot activity in a protected environment. The mechanism ensures the security of APIs by monitoring the flow of requests, validating their sequence integrity, and identifying deviations that signal malicious activity. The mechanism operates by analyzing incoming API requests to determine whether they follow expected patterns, adhere to predefined sequences, and include mandatory steps in the request flow. Such checks are essential for distinguishing legitimate traffic from bot-generated requests, which often bypass critical API calls to directly access sensitive endpoints. Further, the mechanism evaluates API requests in real-time, comparing them against historical patterns and predefined rules to detect anomalies such as missing pre-API calls, unexpected sequences, and irregular invocation paths. For example, in legitimate user interactions, a request to an API endpoint responsible for payment processing would typically be preceded by authentication and validation steps. The mechanism identifies and flags instances where these essential steps are bypassed, as this is a common trait of bot activity. It further assesses the logical relationships between API requests to validate their consistency and coherence, ensuring that requests are properly linked and executed in the intended order.

To achieve accurate detection, the mechanism utilizes a dynamic approach that continuously updates its understanding of normal API behavior by analyzing data trends and adapting to changing usage patterns. The mechanism collects and stores data related to API flows, such as historical invocation chains, expected dependencies, and sequence patterns, enabling it to detect deviations in real-time. Further, the mechanism also evaluates risk based on multiple parameters, including the likelihood of sequence violations, the presence of missing API requests, and abnormal patterns in user interactions. Based on these risk assessments, appropriate actions are taken to mitigate threats, such as blocking suspicious traffic, imposing rate limits, or triggering additional authentication steps.

In an embodiment, the mechanism addresses a critical gap in existing API security systems by focusing on the detection of sophisticated bot activity. Unlike traditional methods such as rate limiting, CAPTCHAs, or static rule-based systems, the mechanism is designed to detect and prevent attacks that exploit vulnerabilities in API flows, such as low-frequency bot attacks or those mimicking human-like behavior. It provides a proactive approach to identifying threats by validating the completeness and integrity of API request flows, which is particularly effective in countering advanced bots that attempt to evade detection by simulating legitimate user interactions. Furthermore, the mechanism enables the protection of sensitive data and prevents API fraud by correlating data across multiple layers, including user behavior, request metadata, and invocation paths. The disclosed mechanism is designed to integrate seamlessly with existing API gateways and backend systems, making it a scalable and adaptable solution for securing APIs in various industries, including e-commerce, banking, and healthcare. By ensuring that only legitimate traffic reaches protected endpoints, the mechanism enhances the security and reliability of API ecosystems while minimizing disruptions to genuine users.

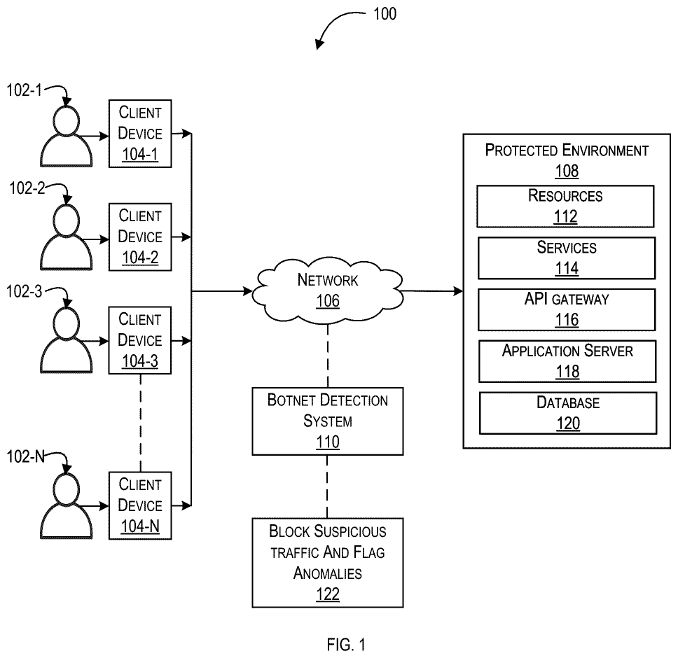

FIG. 1 illustrates an exemplary environment 100 of a system 110 (alternatively also referred to as a bot detection system 110) for detecting and preventing bot activity in a protected environment, in accordance with an embodiment of the present disclosure. As shown in FIG. 1, the exemplary environment 100 may include one or more client devices 104-1, 104-2, 104-3, and 104-N (hereinafter referred to as client device 104), a network 106, a protected environment 108, a bot detection system 110 (alternatively, may also be referred to as a ‘system 110’) an API gateway 116, an application server 118, a database 120, and one or more resources 112 and services 114. The exemplary environment 100 may be established to detect and mitigate bot-based threats in API-driven ecosystems by monitoring API traffic, validating request integrity, and blocking suspicious activities before they impact protected resources.

In an embodiment, the protected environment 108 may include interconnected resources 112 and services 114, which may include, without limitation, servers, cloud-based platforms, applications, and backend processing units. The resources 112 and the services 114 may interact via API calls, facilitating data exchange and transaction processing. To safeguard the interactions, API requests may be processed through the API gateway 116, which acts as a control point for routing and filtering inbound and outbound API traffic. The application server 118 may handle the execution of API-driven functions, while the database 120 may store relevant information, such as user authentication details, session metadata, API request logs, and historical transaction data.

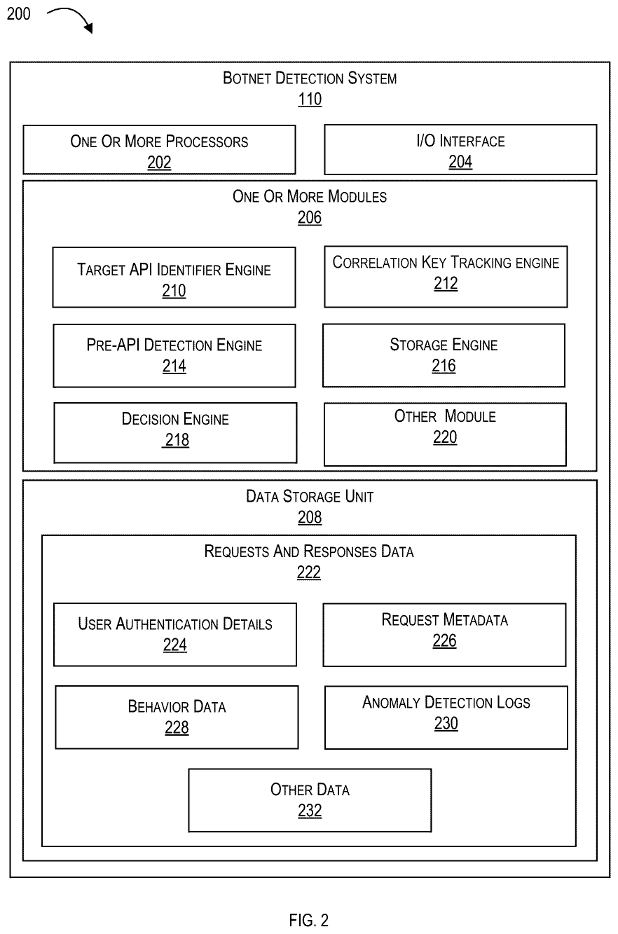

In an embodiment, the bot detection system 110 may be integrated within the environment 100 to monitor API traffic, validate API invocation sequences, and detect anomalies indicative of bot-driven automation. The API requests originating from the client devices 104 may traverse the network 106 before reaching the protected environment 108, where the API requests may undergo sequence integrity validation and correlation key analysis. The system 100 may evaluate API request dependencies, ensuring that expected API flows, including mandatory pre-APIs, are invoked in the correct order before critical services are accessed. The system 110 may further implement risk assessment models to identify and mitigate bot-generated traffic. Further, the API requests failing integrity validation, such as those missing pre-API invocations, appearing in out-of-sequence order, or exhibiting correlation key mismatches, are flagged for security enforcement. Additionally, the system 110 may take automated preventive actions, such as blocking suspicious API traffic, flagging anomalies for administrative review, or applying rate-limiting policies. As illustrated, the system 110 may block suspicious traffic and flag anomalies 122 to ensure that bot-related threats are neutralized before they can compromise protected resources. In an embodiment, by continuously analyzing API request patterns, the bot detection system 110 may provide real-time protection against sophisticated bot attacks, including credential stuffing, automated scraping, fake registrations, and payment fraud. The system 110 may seamlessly integrate with existing API management frameworks and security architectures to enhance API ecosystem resilience against evolving bot threats. Further details regarding the bot detection system 110 and its components are discussed in conjunction with FIG. 2 in the following paragraphs.

FIG. 2 illustrates a detailed block diagram 200 showing functional modules of the system 110 for detecting and preventing bot activity in a protected environment, in accordance with an embodiment of the present disclosure.

In an embodiment, the bot detection system 110 may include one or more processors 202, an Input/Output (I/O) interface 204, one or more modules 206 (may also be termed as one or more engines 206), and a data storage unit 208. In some non-limiting embodiments or aspects, the data storage unit 208 may be communicatively coupled to the one or more processors 202. The data storage unit 208 stores instructions, executable by the one or more processors 202, which on execution, may cause the system 110 to detect anomalies in the protected environment 108 and/or mitigate the effects of such detected anomalies. In some non-limiting embodiments or aspects, the data storage unit 208 may store requests and responses data 222. The one or more modules 206 may perform the steps of the present disclosure using the requests and responses data 222 (whether monitored, received, and/or fetched) associated with one or more API calls associated with the protected environment 108 to detect anomalies. In some non-limiting embodiments or aspects, each of the one or more modules 206 may be a hardware unit, which may be outside the data storage unit 208 and coupled with the system 110. In some non-limiting embodiments or aspects, the system 110 may be implemented in a variety of computing systems, such as a laptop computer, a desktop computer, a Personal Computer (PC), a notebook, a smartphone, a tablet, e-book readers, a server, a network server, a cloud server, and the like. In a non-limiting embodiment, each of the one or more modules 206 may be implemented with a cloud-based server, communicatively coupled with the system 110.

In one implementation, the one or more modules 206 may include, but is not limited to, a target API identifier engine 210, a correlation key engine 212, a pre-API detection engine 214, a storage engine 216, a decision engine 218, and one or more other modules 220 associated with the system 110. The one or more other modules 220 may, without any limitation, include an API sequence integrity validation engine, a collection engine, and/or a report and response engine. In some non-limiting embodiments or aspects, the request and response data 222 stored in the data storage unit 208 may include data associated with user authentication details 224, request metadata 226, behavior data 228, anomaly detection logs 230, and other data 232 associated with the system 110. In some non-limiting embodiments or aspects, such data in the data storage unit 208 may be processed by the one or more modules 206 of the system 110. In some non-limiting embodiments or aspects, the one or more modules 206 may be implemented as dedicated units and when implemented in such a manner, the modules may have the functionality defined in the present disclosure to result in novel hardware. As used herein, the term module may refer to an Application Specific Integrated Circuit (ASIC), an electronic circuit, Field-Programmable Gate Arrays (FPGA), a Programmable System-on-Chip (PSoC), a combinational logic circuit, and/or other suitable components that provide the described functionality. The one or more modules 206 of the present disclosure control the access to the virtual and real-world environment, such that the system 110 may be utilized for detecting anomalies in virtual environments (such as virtual-reality, augmented-reality, or metaverse) similar to the real-world environments that has been focused (for the sake of brevity) in the present disclosure. The one or more modules 206 along with its stored data, may be implemented in any processing system or device for detecting anomalies associated with API security. In a non-limiting embodiment, the proposed processing unit may be implemented within a kernel of a computing device for detecting the anomalies associated with the API security. The kernel along with software and hardware modules of said computing device may function and operate to detect anomalies associated with the API security threats, originating from any of the user devices 104, to the protected environment 108 and mitigate the effects of such anomalies.

In an embodiment, the target API identifier engine 210 may identify APIs that are susceptible to bot-based attacks by analyzing API request parameters including, without any limitation, user sensitive information (either a single user or an organization), payment details, or session tokens to classify such APIs as high-risk based on their sensitivity. Additionally, the target API identifier engine 210 may assess the call volume and usage context of APIs to determine their likelihood of being targeted by bots. It may be apparent to a person skilled in the art that the APIs exhibiting unusually high request frequencies, atypical access patterns, or requests originating from multiple sources within a short time frame are flagged for further analysis. Further, to enhance accuracy, the target API identifier engine 210 may employ Machine Learning (ML) models to classify APIs based on various parameters, including historical call volume and presence of security-sensitive fields. The ML models may dynamically adjust API risk rankings based on ongoing threat intelligence and anomaly detection results, ensuring that bot targeting behaviors are continuously identified and mitigated.

In an embodiment, the correlation key tracking engine 212 may establish logical connections between API requests. The correlation key tracking engine 212 may generate correlation keys from API request headers, cookies, and/or payload attributes, enabling the system to track API flows within a session. The correlation keys may serve as unique identifiers, allowing the correlation key tracking engine 212 to reconstruct user journey pathways and identify anomalies in API request sequences. To refine correlation capabilities, the correlation key tracking engine 212 may create one or more clusters of the correlated keys and assign unique identifiers to correlation keys for tracking API flows to the target API and select statistically significant attributes from historical logs to generate optimal correlation keys. By focusing on user identifiers, session attributes, or device-specific metadata, the correlation key tracking engine 212 may ensure that correlation keys are robust and resistant to bot obfuscation techniques. Further, the correlation key mappings may be maintained in a dedicated storage module, allowing for real-time lookups and integrity validation.

In an embodiment, the pre-API detection engine 214 may ensure that critical API requests are preceded by expected pre-API calls. The pre-API detection engine 214 may evaluate historical API sequences and user workflows to determine which APIs should be invoked before accessing high-risk endpoints. If an API request arrives without its expected pre-API calls, the pre-API detection engine 214 may assign a risk score based on the severity of the omission and the likelihood that the request originates from an automated script. Further, to enhance its ability to track multiple API pathways, the pre-API detection engine 214 may construct an API correlation graph that maps out common user journeys. The correlation graph may account for alternate API paths, parallel processes, and session-dependent workflows, ensuring that legitimate variations in API sequences are not mistakenly flagged as bot activity. Additionally, the pre-API detection engine 214 may assign replacement APIs to expected pre-APIs, determining whether alternative API calls serve a similar function within a given workflow.

In an embodiment, the API sequence integrity engine may verify whether API requests adhere to historically observed invocation patterns. The API sequence integrity engine may assign likelihood scores to API sequences by comparing the sequence of real-time API requests to the sequence of correlated pre-APIs. The requests deviating from established patterns may be flagged for further analysis, with high-risk deviations triggering immediate security enforcement measures. Further, to detect low-frequency and adaptive bot behaviors, the API sequence integrity validation engine may continuously update its sequence likelihood models based on new traffic patterns. Additionally, the API sequence integrity engine may monitor sudden spikes in usage of uncommon API paths, as these may indicate the presence of automation frameworks attempting to bypass conventional security measures.

In an embodiment, the storage engine 216 may maintain structured API tracking data. The storage engine 216 may consist of multiple storage components, each designed for a specific aspect of API behavior analysis. The target API store may retain metadata associated with sensitive APIs, while the correlation key store maintains mappings of correlation keys and their associated API flows. Similarly, the pre-API store may track expected API invocation sequences, and the path integrity store records valid API invocation pathways. By caching API flow information, the storage engine 216 may enable real-time request validation, efficient correlation key lookups, and rapid anomaly detection. Further, the storage engine 216 may dynamically update its contents based on recent API traffic patterns and risk assessment results, ensuring that the storage engine 216 may remain adaptive to evolving bot tactics.

In an embodiment, the decision engine 218 may flag suspicious bot activity based on the results of the comparison by analyzing incoming API requests and determine whether the API request exhibits bot-like characteristics. The decision engine 218 may evaluate API flows for missing pre-APIs, correlation key mismatches, and sequence integrity violations, assigning dynamic risk scores to each request. If an API request fails multiple validation checks, the decision engine 218 may block subsequent API requests to the target API if a number of subsequent API requests not following the determined sequence of API requests exceed a predefined threshold. Further, the decision engine 218 flags suspicious bot activity of the comparison indicates that one or more of a critical API and a closely resembling API to the critical API is missing from the sequence of correlated pre-APIs, wherein such indication from comparison is determined if difference is more than a pre-defined threshold. Additionally, the decision engine 218 may dynamically adjust its risk thresholds based on administrator-defined configurations, historical security incidents, or evolving attack trends. To mitigate bot activity in real-time, the decision engine 218 may implement adaptive response measures that escalate based on risk levels. Low-risk anomalies may trigger additional authentication steps, whereas high-risk bot activity may result in immediate blocking or rate limiting of API requests. Such enforcement actions may dynamically be updated based on security policies or automated learning models, ensuring that mitigation strategies remain effective against new and emerging bot techniques.

In some embodiments, the one or more other modules 220 may include the collection engine to collect request and response data of one or more API calls during one or more user sessions. It may be noted that for the sake of the present disclosure, the one or more user sessions correspond to a period of time in which the user accesses the protected environment 108, i.e., period during which users initiate API calls and receive a response to API calls, including API calls made during authentication, authorization and any subsequent request and response to and from any of the resources 112 or services 114. Such one or more API calls may be associated with the protected environment 108, such as based on the communication of the one or more components of the protected environment 108 either with each other or with one or more components out of the protected environment 108. The one or more API calls may have been initiated by one or more users and/or services. Further, the one or more API calls may, without any limitation, include initial authentication, authorization, and one or more Hyper Text Transfer Protocol (HTTP) requests and responses during a user session. In a non-limiting example, the one or more API calls are generated whenever a user logs into a client device, accesses a network, accesses a web address, opens an application, copies a file, pastes a file, opens settings, makes an internal function call, make external function calls, or perform any other operation in the protected environment 108. In another non-limiting example, the one or more API calls may be generated when a service performs an action, such as accessing a database, connecting to a network, opening a webpage, connecting to a server, transferring data to the server, downloading data from the server, or the like.

In some embodiments, the collection engine may store the collected request and response data 222 in the data storage unit 208 for detailed analysis at any point in time. The storing of the response and request data may facilitate the system 110 to understand a behavioral change (of a user, or a client device, or an application, or a service, or a network) that occurs over time (e.g., over days, weeks, or months) and may be utilized to determine and analyze a complete picture of a sophisticated API attack has been conducted and/or evolved step-by-step targeting across multiple attack phases. The collected request and response data 222 associated with API calls may form an API data lake. The API data lake may provide 360-degree contextual data on each of the API calls.

In some embodiments, the one or more other modules 220 may include the report and response engine to report the detected abnormal user behavior. In an embodiment, the report and response engine may send reports of the detected abnormal user behavior to a concerned person, such as a system administrator, a user, a security manager, an IT manager, an owner, or the like to facilitate the concerned person to validate the detected user behavior. Further, the report and response engine may take necessary actions to mitigate the effects of the abnormal user behavior based on the validation of the concerned person. In another embodiment, the report and response engine may automatically take the necessary action to mitigate the effects of the abnormal user behavior if magnitude of associated threat is more than a pre-defined threshold.

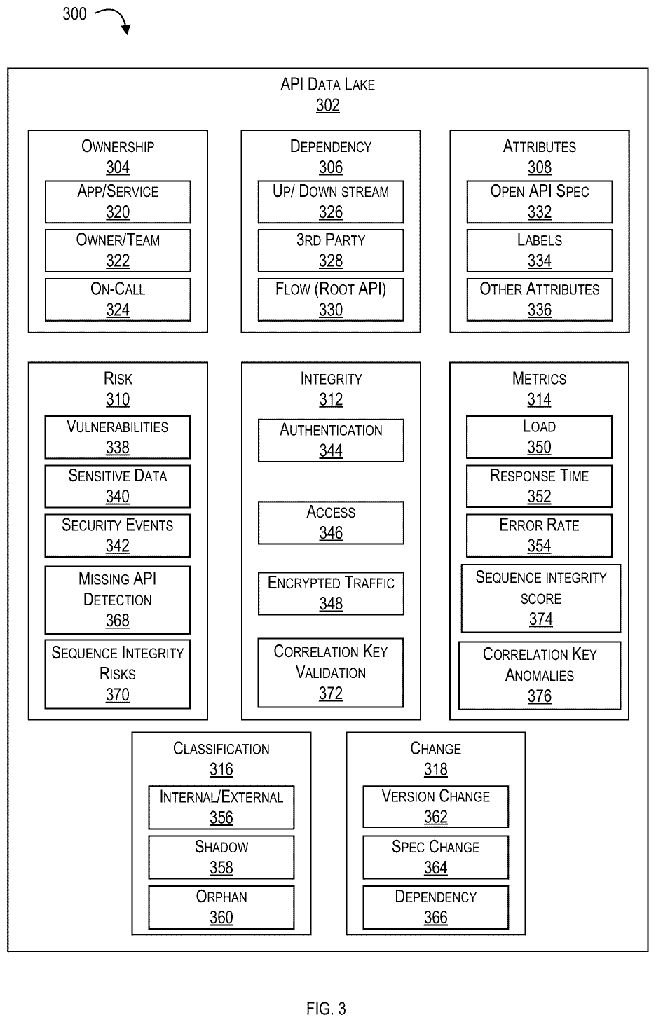

FIG. 3 shows exemplary data 300 that is stored in an API data lake 302, in accordance with an embodiment of the present disclosure. The API data lake 302 may maintain a 360-degree context of each APIs and request and response data of each API calls. It may be noted that the full context of the general behavior may require capturing and learning from every API call. In an embodiment, the API calls for the API may be associated with commands such as external, internal, mirror, edge in-app, serverless, and 3^{rd} party and partner. In an illustrated embodiment, the data lake may be the API data lake 302 that may store data associated with ownership 304, dependency 306, attributes 308, risk 310, integrity 312, metrics 314, classification 316, and change 318 associated with each of APIs. The API data associated with ownerships 304 may, without any limitation, be related to app/service ownership 320, user/team ownership 322, and on-call ownership 324. The API data associated with dependency 306 may, without any limitation, be related to up/downstream dependency 326, 3^{rd} party dependency 328, and flow i.e., root API dependency 330. The API data associated with attributes 308 may, without any limitation, be related to open API specification 332, labels 334, and other attributes 336. The API calls associated with risk 310 may, without any limitation, be related to vulnerability type 338, sensitive data type 340, security event types 342, missing API detection 368, and sequence integrity risks 370. The API data associated with integrity 312 may, without any limitation, be related to authentication integrity 344, access integrity 346, encrypted traffic integrity 348, and correlated key validation 372. The API data associated with metrics 314 may, without any limitation, be related to load 350, response time 352, error data 354, sequence integrity score 374, and correlation key anomalies 376. The API data associated with classification 316 may, without any limitation, be related to internal/external 356, shadow 358, and orphan 360. The API data associated with change 318 may, without any limitation, be related to version change 362, specification change 364, and dependency change 366.

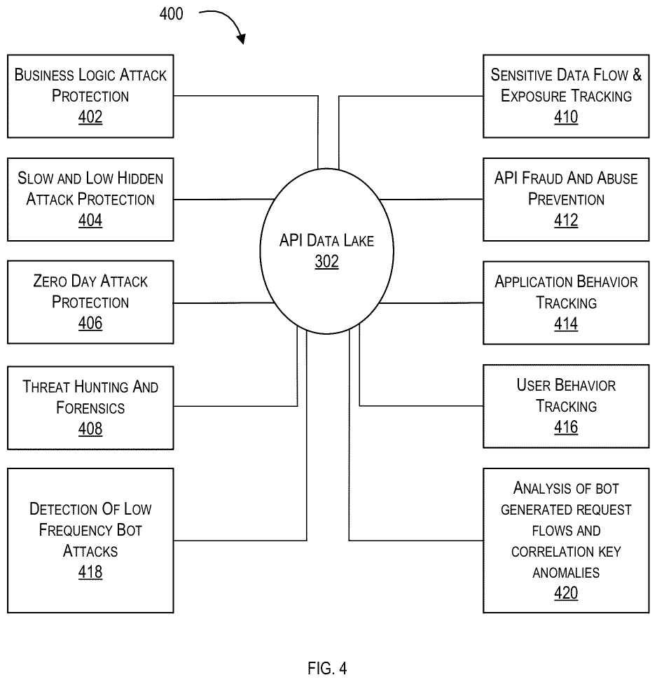

FIG. 4 shows exemplary uses 400 of the API data lake 302 that provides 360-degree contextual data of each API, in accordance with an embodiment of the present disclosure. In an embodiment, as illustrated in FIG. 4, the system 110 may provide protections against bot-generated threats, low-frequency attacks, and other API vulnerabilities, as well as tracking and analyzing API behavior to identify malicious patterns. In an embodiment, the functionality may include a business logic attack protection 402, which safeguards the API ecosystem against automated attempts to exploit vulnerabilities in business logic, such as bypassing payment validation, abusing discounts, or misusing application features. The business logic attack protection 402 may ensure that business workflows remain secure against logic manipulation. In an embodiment, the functionality may include a slow and low hidden attack protection 404 to detect and mitigate subtle bot strategies that operate under the radar of traditional detection mechanisms. The attacks may generate API requests at low frequencies and blend into normal traffic patterns to evade rate-limiting or anomaly detection systems. By leveraging the API data lake 302, the slow and low hidden attack protection 404 may analyze long-term trends in API behavior, identify inconsistencies in session flows, and flag requests exhibiting characteristics of hidden, slow-moving bot activity. In an embodiment, the functionality may include a zero-day attack protection 406 functionality that detects and prevents exploitation of newly discovered vulnerabilities in APIs. By analyzing API behavior in real-time and comparing it against established baselines, the zero-day attack protection 406 functionality proactively mitigates risks even before security patches are applied.

In an embodiment, the functionality also includes a threat hunting and forensics 408 that enables proactive investigation into potential security incidents by analyzing API request logs, behavioral deviations, and anomalies stored in the API Data Lake 302. Such functionality supports both real-time threat hunting and post-incident forensics, helping to uncover the tactics and strategies used by bots. In an embodiment, the functionality also includes the detection of low-frequency bot attacks 418 that focuses on identifying bot activity that mimics human-like behavior by generating infrequent but strategically targeted API requests. Such low-frequency attacks often evade traditional rate-limiting and anomaly detection systems, but by leveraging historical data and behavior models stored in the API Data Lake 302, the system 110 may identify patterns characteristic of the bot activities. In an embodiment, the functionality may include a sensitive data flow and exposure tracking 410 functionality which monitors the flow of sensitive data, such as user credentials, payment information, and session tokens, across the API ecosystem. The sensitive data flow and exposure tracking 410 functionalities may ensure that sensitive information is not accessed or transmitted in an unauthorized manner and alerts administrators to potential data breaches.

In an embodiment, the functionality also includes an API fraud and abuse prevention 412 functionality, which identifies misuse of APIs, including fraudulent transactions, credential stuffing attacks, and abuse of system resources. By analyzing behavioral patterns and historical usage data, this functionality enables proactive detection and prevention of abuse scenarios. In an embodiment, the functionality also includes an application behavior tracking 414 and user behavior tracking 416 functionalities which monitor the interactions of applications and users with the API environment, respectively. The application behavior tracking focuses on anomalies in service-to-service communications, while user behavior tracking evaluates deviations in user activity, such as unauthorized access attempts or sudden spikes in request volumes. In an embodiment, the functionality also includes an analysis of bot-generated request flows and correlation key anomalies 420 functionality is a key enhancement in the CIP. Such functionality leverages the API data lake 302 to analyze bot-generated traffic patterns, such as missing API calls, out-of-sequence requests, and unexpected deviations in correlation keys. By identifying and validating correlation key chains, this functionality provides advanced insights into bot behavior, enabling real-time detection and prevention of bot-driven API misuse.

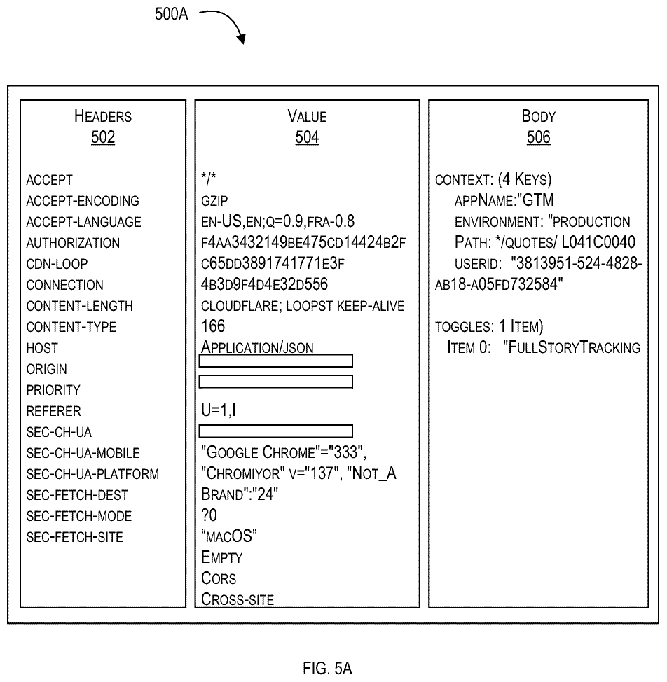

FIG. 5A shows a correlation key tracking mechanism 500A, in accordance with an embodiment of the present disclosure. FIG. 5B shows a correlation key chain construction 500B, in accordance with an embodiment of the present disclosure. For the sake of brevity, FIGS. 5A and 5B have been explained together.

In an embodiment, a correlation key may be defined as one or a group of identifiers that, when used collectively, provide visibility into the chain of requests invoked by a user or bot. Such correlation keys may be derived from various parts of the API schema, including request and response bodies, headers, and cookies. For instance, a correlation key may be a standalone attribute, such as an IP address, a combination of attributes, such as IP+user agent+cookie_1+specific body attributes, or an extracted or derived attribute obtained from the request payload. As shown in FIG. 5A, the correlation key tracking mechanism 500A may include headers 502, values 504, and a body 506. The headers 502 may include attributes such as Accept, Authorization, Host, Origin, Priority, and other metadata fields essential for identifying and tracking API requests. The values 504 may provide specific information associated with these headers, such as user agent strings, content types, and browser characteristics. Additionally, the body 506 may capture contextual data, including the application name, environment details, user session IDs, and toggles, enabling precise tracking of API request flows.

In another embodiment, the correlation key engine 212 may operate by analyzing historical data to select a statistically significant sample of users or sessions. The correlation key engine 212 may ingest target APIs identified by the system 110 and evaluate their headers, cookies, and body attributes. The correlation key engine 212 may conduct searches to identify combinations of header and cookie values that fetch the maximum number of APIs in a chain of requests ending at the target API. For example: API requests may include attributes such as <header_1+cookie_1> (510A), <header_2+cookie_2> (510E), or combinations thereof. The resulting chain is constructed by correlating combinations across APIs, as illustrated in FIG. 5B that elaborates on the chain construction process. It depicts a sequence of API requests, including API 1 508A, API 2 508B, API 3 508C, API 4 508D, API 5 508E, API 6 508F, and API 7 508G. These APIs may be linked through their correlation keys APIs 508A, 508B, and 508C share a common combination <header_1+cookie_1> (510A-510C). APIs 508D, 508E, 508F, and 508G share a different combination <header_2+cookie_3> (510D-510H). The correlation occurs at API 508D, which shares both combination 1 (<header_1+cookie_1>) and combination 2 (<header_2+cookie_3>), enabling the system to construct a comprehensive chain from API 508A to API 508G. To ensure robust performance, each key combination may be assigned a unique correlation key identifier (Correlation Key ID). The identifiers may be sorted in descending order based on the number of APIs fetched, forming a waterfall model. Such a model may be deployed into the system's configuration to ensure seamless operation, even when some top-level correlation keys are absent. Further, the waterfall approach may ensure that the detection mechanism remains operational under varying conditions, maintaining visibility across API request chains. In an embodiment, the correlation key tracking engine 212 may analyze real-time API requests and validate them against pre-constructed correlation key chains. Deviations, such as missing attributes or unexpected combinations, may be flagged as anomalies.

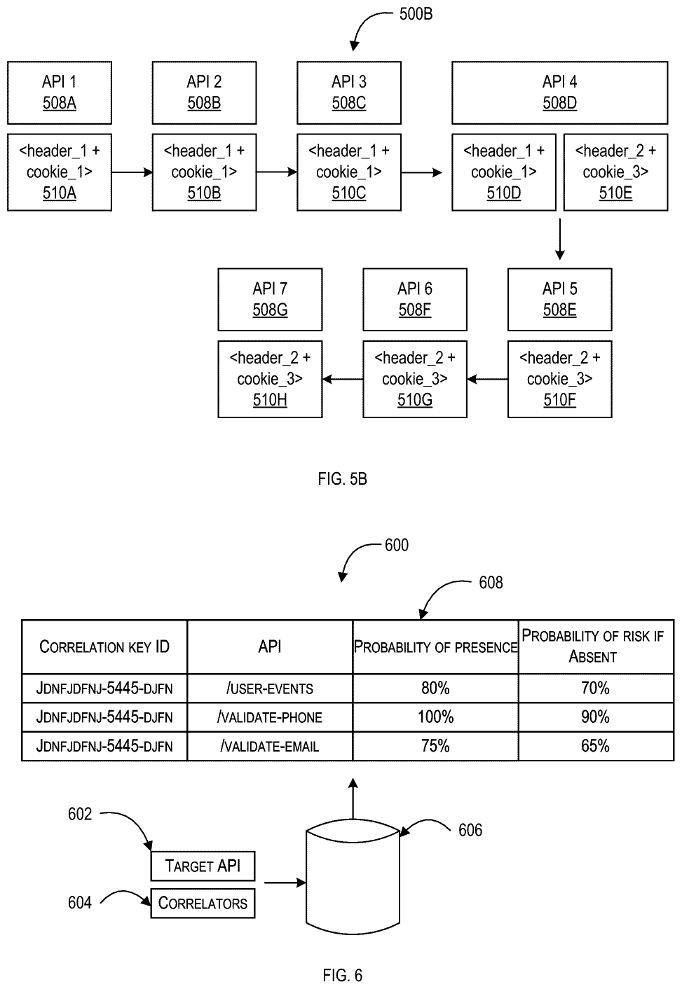

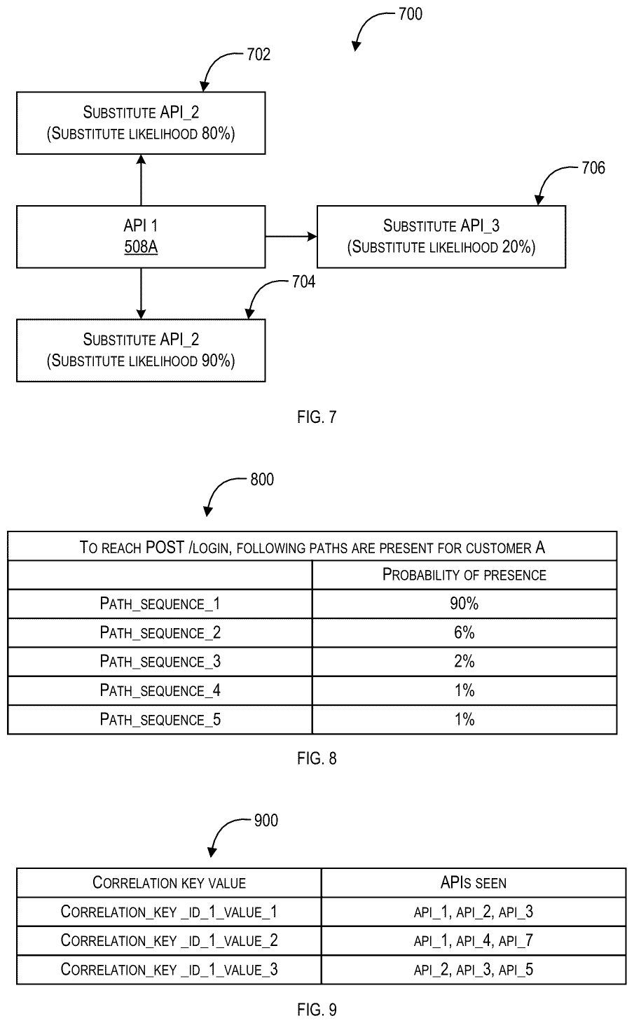

FIG. 6 shows exemplary pre-API detection workflow 600, in accordance with an embodiment of the present disclosure. FIG. 7 shows an API sequence integrity analysis model 700, in accordance with an embodiment of the present disclosure. FIG. 8 shows a bot detection decision flow 800, in accordance with an embodiment of the present disclosure. For the sake of brevity, FIGS. 6, 7, and 8 have been explained together.

In an embodiment, as illustrated in FIG. 6, a mechanism for identifying and assigning risks to pre-APIs is shown, which are mandatory or probable API calls that are expected to precede requests to a target API. The workflow 600 may begin with an hourly sampler that may run periodic checks to ingest target APIs 602 and may fetch Correlation Key IDs 604. In an embodiment, historical data may be analyzed to determine which API requests frequently occur before the target API, enabling the identification of mandatory and probable pre-APIs. Further, as illustrated by table 608 that may be associated with a database 606, each pre-API may be associated with probability of presence i.e., the likelihood that the pre-API will appear in the flow leading to the target API and probability of risk if absent i.e., the risk level assigned to the flow if the pre-API is missing. For example, pre-APIs such as /user-events, /validate-phone, and /validate-email are analyzed to determine their frequency and importance. If the /validate-phone API has a high probability of presence (100%) and a high-risk probability when absent (90%), it indicates that its absence could signify malicious traffic or bot activity. The system 110 may cache these insights and label the identified APIs as pre-APIs for subsequent validation against incoming requests.

In another embodiment, as illustrated in FIG. 7, a mechanism for managing multiple pathways in the user journey to a target API may be shown and referred to as API correlation graph construction. In an embodiment, the APIs that can substitute each other based on the pathway taken are extracted. For example, when a pre-API such as API 1 508A is absent, the system 110 identifies and validates possible substitutes such as substitute API_2 702 and substitute API_3 706. Each substitute API may be assigned a substitution likelihood based on its historical presence and importance in the flow. As illustrated, if the/validate-email pre-API is missing, there is a high likelihood (90%) that an SSO provider API 704 or an OTP provider API 702 may be present. Such substitutes may ensure the continuity of API workflows and help the system 110 detect deviations when expected substitutes are also absent or misused by bots. Further, as shown in FIG. 8, an API sequence integrity identification mechanism may be used to validate all possible paths that users or systems may take to reach a target API, such as POST/login. Such a mechanism assigns a likelihood score to each path based on historical data. For instance, Path_sequence_1 may have a 90% probability of presence, while less common paths like Path_sequence_2 or Path_sequence_3 have significantly lower probabilities (6% and 2%, respectively). These likelihood scores indicate the frequency of usage among legitimate users. In an embodiment, the system 110 may analyze such sequences using historical data from a statistically significant number of users verified as legitimate through existing bot detection methods. The system 110 may also ensure that sudden spikes in the presence of rarely used paths, such as Path_sequence_4 or Path_sequence_5 (each with only 1% historical probability), are flagged as potential indicators of bot traffic.

FIG. 9 shows a storage engine and API flow validation model 900, in accordance with an embodiment of the present disclosure. In an embodiment, sequence, and rate store may play a critical role in caching and tracking real-time information related to API requests, enabling validation of API flows and detection of anomalies indicative of bot activity. Further, the sequence and rate store may operate within a broader memory store framework, which may include components such as the target API store, correlation key store, pre-API store, replace API store, and path integrity store. Together, such components may provide a comprehensive mechanism for validating API behaviors and ensuring secure operation in the presence of potential automated threats. Furthermore, the sequence and rate store may be organized as a key-value pair table, where each row may represent a correlation key value and the associated APIs seen for that value. For example, a correlation key value such as Correlation_Key_ID_1_Value_1 may be linked to the sequence of APIs API_1, API_2, and API_3, while another correlation key value Correlation_Key_ID_1_Value_2 may correspond to the sequence API_1, API_4, API_7. This organization may allow the system 110 to track API requests as they occur, updating the table dynamically to reflect real-time request patterns and ensuring efficient monitoring of API flows.

In an embodiment, when an API request for a target API is received, the system 110 may first reference the correlation key store to identify the relevant correlation keys and their corresponding values. Using this information, the sequence and rate store are updated to include the target API in the “APIs Seen” column for the appropriate correlation key rows. The system 110 may then filter and merge recently updated rows to create a comprehensive chain of API requests. Such a reconstructed chain may represent the true path taken by the user or bot, enabling the system to perform further analysis and validation. In an embodiment, system 110 next may validate the reconstructed chain against the pre-API store, which may contain a record of mandatory pre-APIs for each target API, along with their importance and associated risks. If any key pre-API is found to be missing, the system 110 may query the replace API store to identify possible substitutes. If substitute APIs are present and their substitution likelihood exceeds a configured threshold, the flow continues. However, if no valid substitutes are found, the system 110 may track all API requests to the target API that are missing the same pre-APIs and monitor them against a configured rate threshold. If this threshold is breached, subsequent API requests to the target API are blocked and labeled as bot traffic. The system 110 may also validate the path integrity of the API request chain using the path integrity store, which may contain all possible API paths and their probabilities of occurrence. If the path taken by the user or bot deviates from established patterns or fails to maintain integrity, the system 110 may block the traffic based on a risk threshold configured by analysts. If the path integrity is maintained and the risk threshold is not breached, the traffic is allowed to proceed to the platform. By leveraging the sequence and rate store in conjunction with other memory store components, the system 110 may enable real-time validation of API request patterns, identify missing or substituted APIs, and ensure the integrity of user and bot flows.

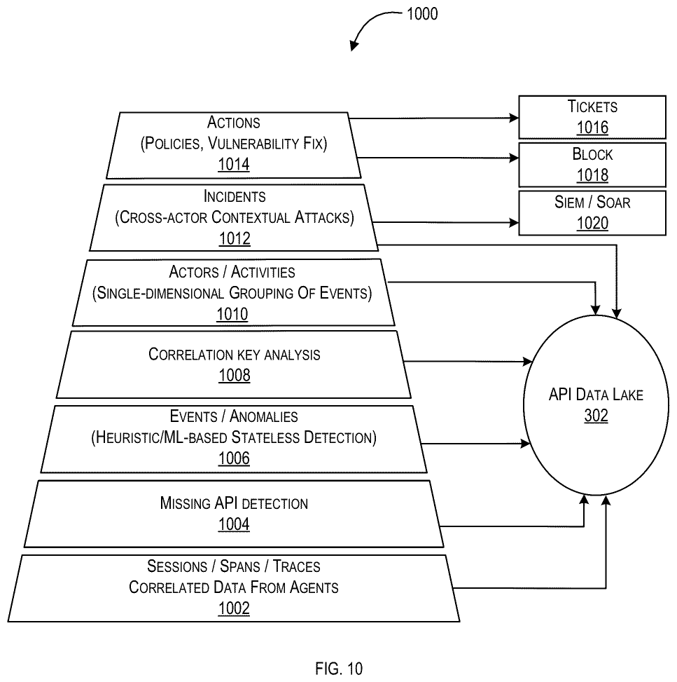

FIG. 10 shows a block diagram 1000 illustrating an exemplary data collection and bot detection workflow, in accordance with an embodiment of the present disclosure. In an embodiment, the bot detection system 110 may be designed to deliver actionable insights and automated remediation workflows for detecting and mitigating bot-related API threats. The system 110 may provide manageable, explainable, and actionable reports or dashboards with a focus on reducing false positives. By dynamically determining anomaly baselines through machine learning models and incorporating feedback from earlier confirmed or rejected incidents, the system 110 may minimize false positives while improving incident response accuracy.

Initially, data correlation, as depicted at block 1002, may be performed where sessions, spans, and traces correlated from agents (users or services) are aggregated into the API data lake 302. Such a correlation may provide a holistic view of API interactions across multiple sessions and enables comprehensive analysis. Based on this correlated data, the system 110 may perform heuristic and machine-learning-based stateless detection of events and anomalies for various use cases, as shown at block 1004. For example, the system 110 may detect deviations in API request patterns, anomalies in correlation key usage, or unexpected behaviors indicative of bot-generated traffic. The detection of missing APIs, correlation key anomalies, and sequence integrity violations is a critical part of this stage. Next, at block 1006, the system 110 may group events and anomalies into single-dimensional representations of actors and activities, enabling the identification of high-risk entities. Such groupings may allow the system 110 to detect patterns of behavior that may not be evident in individual API requests, facilitating the identification of malicious actors and their associated activities. Using such grouped data, the system 110 may perform correlation key analysis, as shown at block 1008, to reconstruct API invocation sequences and validate their integrity.

Next, at block 1010, the system 110 may perform cross-actor contextual attack detection to identify incidents which may include analyzing interactions between multiple actors to uncover coordinated attacks, such as distributed bot operations targeting specific APIs. Identified incidents are flagged and stored for further review and response. Based on the detected incidents, the system 110 may recommend or take remediation actions, as shown at block 1014. Such actions may, without any limitation, include applying policies, initiating vulnerability fixes, or executing automated mitigation strategies to neutralize identified threats. For example, the system 110 may block bot-generated traffic, enforce rate limits, or redirect suspicious requests to alternative workflows.

In an embodiment, the collected data, detected events and anomalies, grouped actors and activities, detected incidents, and actions taken may be stored in the API data lake 302 for historical analysis and audit purposes. The stored data may support continuous learning and improvement of detection models. In an embodiment, the system 110 may facilitate response actions by generating tickets 1016 in external tools such as Jira, ServiceNow, or Slack. Such tickets 1016 may be assigned to appropriate personnel for manual investigation or resolution. Additionally, the system 110 may automatically take immediate action to block users, devices, or services involved in bot-driven attacks, as shown by the 1018. As shown in block 1020, the system 110 may also integrate with Security Information and Event Management (SIEM) tools or Security Orchestration, Automation, and Response (SOAR) tools.

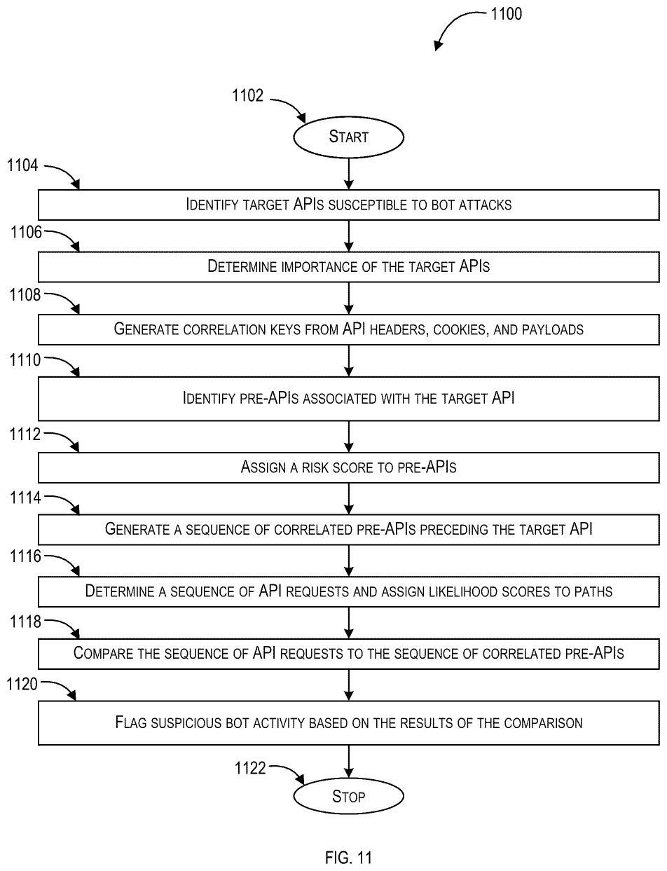

FIG. 11 is a flow chart 1100 of a method for detecting and preventing bot activity in a protected environment, in accordance with an embodiment of the present disclosure. The method starts at step 1102.

In an embodiment, at step 1104, the method may include the steps of identifying target APIs that are susceptible to bot attacks by analyzing API body parameters, including user sensitive information (either a single user or an organization), payment information, and/or session tokens. Next, at step 1106, the method may include the steps of determining the importance of the target APIs based on factors such as average call volume and usage context to assess the likelihood of bot exploitation. Further, at step 1108, the method may include the steps of generating correlation keys from API headers, cookies, and/or payloads to create logical chains of API requests, enabling the tracking of API invocation sequences. Next, at step 1110, the method may include the steps of identifying pre-APIs associated with the target API based the generated correlation keys. The method may also include the steps of assigning unique identifiers to correlation keys to ensure accurate monitoring of API flows directed to ward target APIs. The method may include the steps of selecting statistically significant user data from historical logs to derive optimal correlation keys that enhance tracking precision and prevent bot obfuscation.

In an embodiment, at step 1112, the method may include the steps of assigning a risk score to the pre-APIs based on their frequency and criticality within the API workflow. Further, the method may include the steps of constructing an API correlation graph to handle multiple pathways in the user journey toward the target API, ensuring that legitimate variations in API sequences are accounted for while detecting bot-generated traffic. Additionally, the method may include the steps of assigning replacement APIs for missing pre-APIs and determining their likelihood of substitution based on usage patterns. Next, at step 1114, the method may include the steps of generating, based on the assigned risk score, a sequence of correlated pre-APIs preceding the target API. In an embodiment, at step 1116, the method may include the steps of determining a sequence of API requests and assigning likelihood scores to API paths based on historical data. Next, at step 1118, the method may include the steps of compare the sequence of API requests to the sequence of correlated pre-APIs to detect unauthorized deviations. Further, the method may include the steps of calculating sequence likelihood scores by comparing current API paths with historical data validated as benign. Additionally, the method may include the steps of monitoring sudden spikes in the usage of uncommon paths to detect malicious traffic patterns. Furthermore, the method may include the steps of caching data related to target APIs, correlation keys, pre-APIs, replacement APIs, and sequence paths for real-time lookups. The method may include the steps of maintaining a structured data storage mechanism, including a target API store for caching metadata, a correlation key store for tracking API mappings, a pre-API store for storing pre-APIs and their associated risk scores, and a path integrity store for recording valid API sequences and their probability scores.

In an embodiment, the method may include the steps of analyzing incoming API requests for missing pre-APIs or deviations in sequence integrity. Next, the method may include the steps of validating substitute APIs against replacement thresholds to ensure that missing pre-API calls do not introduce vulnerabilities in API workflows. Thereafter, at step 1120, the method may include the steps of flagging suspicious bot activity based on the results of the comparison if the comparison indicates that one or more of: a critical API and a closely resembling API to the critical API is missing from the sequence of correlated pre-APIs, wherein such indication from comparison is determined if difference is more than a pre-defined threshold. Further, the method may include the steps of blocking API requests flagged as bot traffic based on predefined risk thresholds. Additionally, the method may include the steps of dynamically updating risk thresholds based on administrator-defined configurations or historical incident data. Further, the method may include the steps of blocking subsequent API requests to the target API if a number of subsequent API requests not following the determined sequence of API requests exceed a predefined threshold. Accordingly, the method may include enabling real-time detection and mitigation of bot activity within a protected API environment, ensuring the prevention of automated attacks while maintaining seamless operation for legitimate users. The method ends at step 1122.

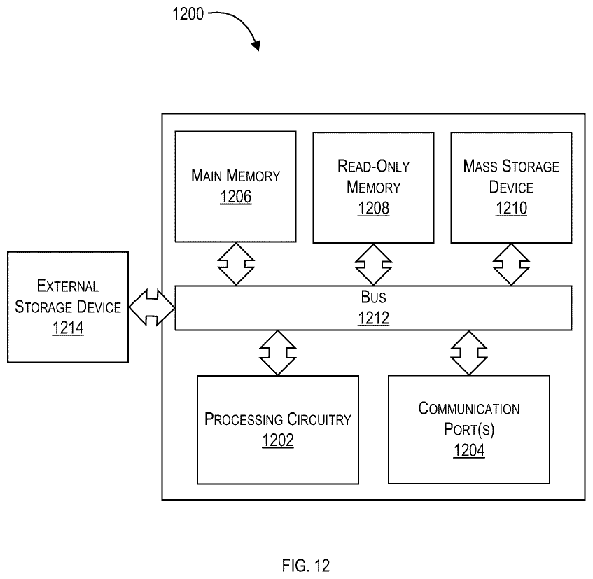

FIG. 12 illustrates an exemplary computer system in which or with which embodiments of the present disclosure may be utilized. As shown in FIG. 12, a computer system 1200 includes an external storage device 1214, a bus 1212, a main memory 1206, a read-only memory 1208, a mass storage device 1210, a communication port 1204, and a processor 1002.

Those skilled in the art will appreciate that computer system 1200 may include more than one processor 1202 and communication ports 1204. Examples of processor 1202 include, but are not limited to, an Intel® Itanium® or Itanium 2 processor(s), or AMD® Opteron® or Athlon MP® processor(s), Motorola® lines of processors, FortiSOC™ system on chip processors or other future processors. The processor 1202 may include various modules associated with embodiments of the present disclosure.

The communication port 1204 can be any of an RS-232 port for use with a modem-based dialup connection, a 10/100 Ethernet port, a Gigabit or 10 Gigabit port using copper or fiber, a serial port, a parallel port, or other existing or future ports. The communication port 1204 may be chosen depending on a network, such as a Local Area Network (LAN), Wide Area Network (WAN), or any network to which the computer system connects.

The memory 1206 can be Random Access Memory (RAM), or any other dynamic storage device commonly known in the art. Read-Only Memory 808 can be any static storage device(s) e.g., but not limited to, a Programmable Read-Only Memory (PROM) chips for storing static information e.g., start-up or BIOS instructions for processor 1202.

The mass storage 1210 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

The bus 1212 communicatively couples processor(s) 1202 with the other memory, storage, and communication blocks. The bus 1212 can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 1202 to a software system.

Optionally, operator and administrative interfaces, e.g., a display, keyboard, and a cursor control device, may also be coupled to bus 1204 to support direct operator interaction with the computer system. Other operator and administrative interfaces can be provided through network connections connected through communication port 1204. An external storage device 1210 can be any kind of external hard-drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

Thus, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices can exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the disclosure, other and further embodiments of the disclosure may be devised without departing from the basic scope thereof. The scope of the invention is determined by the claims that follows. The invention is not limited to the described embodiments, versions, or examples, which are included to enable a person having ordinary skill in the art to make and use the disclosure when combined with information and knowledge available to the person having ordinary skill in the art.

What is claimed is:

1. A system for detecting and preventing bot activity in a protected environment, the system comprising:
a target API identifier engine configured to:
identify target APIs susceptible to bot attacks by analyzing API body parameters, including at least one of: user sensitive information, payment information, and session tokens; and
determine importance of the target APIs based on average call volume and usage context;
a correlation key tracking engine configured to generate correlation keys from at least one of: API headers, cookies, and payloads to create chains of API requests;
a pre-API detection engine configured to:
identify pre-APIs associated with the target API based on the generated correlation keys; and
assign a risk score to the pre-APIs based on their frequency and criticality; and
generate, based on the assigned risk score, a sequence of correlated pre-APIs preceding the target API;
an API sequence integrity engine configured to:
determine a sequence of API requests and assign likelihood scores to paths based on historical data; and
compare the sequence of API requests to the sequence of correlated pre-APIs;
a decision engine configured to flag suspicious bot activity based on the results of the comparison.

2. The system of claim 1, wherein the correlation key engine is configured to:
create one or more clusters of the correlated keys and assign unique identifiers to correlation keys for tracking API flows to the target API; and
select statistically significant user data from historical logs to derive optimal correlation keys.

3. The system of claim 1, wherein the pre-API detection engine constructs an API correlation graph to handle multiple pathways in the user journey to the target API.

4. The system of claim 1, wherein the API sequence integrity engine calculates sequence likelihood scores by comparing current API paths with historical data validated as benign.

5. The system of claim 1, wherein the decision engine blocks subsequent API requests to the target API if a number of subsequent API requests not following the determined sequence of API requests exceed a predefined threshold.

6. The system of claim 1, further comprising a storage engine configured to cache data related to target APIs, correlation keys, pre-APIs, replacement APIs, and sequence paths for real-time lookups, wherein the store engine includes:
a target API store for caching target APIs and their metadata;
a correlation key store for maintaining mappings of correlation keys and their associated APIs;
a pre-API store for storing pre-APIs and their risk scores; and
a path integrity store for recording valid paths and their probabilities.

7. The system of claim 1, wherein the target API identifier engine uses machine learning models to classify sensitive APIs based on parameters including average call volume and presence of critical data fields.

8. The system of claim 1, wherein the pre-API detection engine assigns replacement APIs for missing pre-APIs and determines their likelihood of substitution based on usage patterns.

9. The system of claim 1, wherein the decision engine is further configured to:
flag suspicious bot activity if the comparison indicates that one or more of: a critical API and a closely resembling API to the critical API is missing from the sequence of correlated pre-APIs, wherein such indication from comparison is determined if difference is more than a pre-defined threshold; and
dynamically updates risk thresholds based on administrator-defined configurations or historical incident data.

10. The system of claim 1, wherein the API sequence integrity engine monitors sudden spikes in usage of uncommon paths to detect malicious traffic patterns.

11. A method for detecting and preventing bot activity in a protected environment, the method comprising:
identifying target APIs susceptible to bot attacks by analyzing API body parameters, including at least one of: user sensitive information, payment information, and session tokens;
determining importance of the target APIs based on average call volume and usage context;
generating correlation keys from at least one of: API headers, cookies, and payloads to create chains of API requests;
identifying pre-APIs associated with the target API based on the generated correlation keys;
assigning a risk score to the pre-APIs based on their frequency and criticality;
generating, based on the assigned risk score, a sequence of correlated pre-APIs preceding the target API;
determining a sequence of API requests and assigning likelihood scores to paths based on historical data;
compare the sequence of API requests to the sequence of correlated pre-APIs;
flagging suspicious bot activity based on the results of the comparison.

12. The method of claim 11, further comprising:
creating one or more clusters of the correlated keys and assigning unique identifiers to correlation keys for tracking API flows to the target API; and
selecting statistically significant user data from historical logs to derive optimal correlation keys.

13. The method of claim 11, further comprising constructing an API correlation graph to handle multiple pathways in the user journey to the target API.

14. The method of claim 11, wherein the API sequence integrity engine calculates sequence likelihood scores by comparing current API paths with historical data validated as benign.

15. The method of claim 11, further comprising blocking subsequent API requests to the target API if a number of subsequent API requests not following the determined sequence of API requests exceed a predefined threshold.

16. The method of claim 11, further comprising caching data related to target APIs, correlation keys, pre-APIs, replacement APIs, and sequence paths for real-time lookups, wherein the storage includes:
a target API store for caching target APIs and their metadata;
a correlation key store for maintaining mappings of correlation keys and their associated APIs;
a pre-API store for storing pre-APIs and their risk scores; and
a path integrity store for recording valid paths and their probabilities.

17. The method of claim 11, further comprising using machine learning models to classify sensitive APIs based on parameters including average call volume and presence of critical data fields.

18. The method of claim 11, further comprising assigning replacement APIs for missing pre-APIs and determines their likelihood of substitution based on usage patterns.

19. The method of claim 11, further comprising:
flagging suspicious bot activity if the comparison indicates that one or more of: a critical API and a closely resembling API to the critical API is missing from the sequence of correlated pre-APIs, wherein such indication from comparison is determined if difference is more than a pre-defined threshold; and
dynamically updating risk thresholds based on administrator-defined configurations or historical incident data.

20. The method of claim 11, further comprising monitoring sudden spikes in usage of uncommon paths to detect malicious traffic patterns.
